(19) United States
(12) Patent Application Publication
(10) Pub. No.: US 2005/0061122 A1
(43) Pub. Date: Mar. 24, 2005

(54) Sawing machine and a method for controlling the drive of a sawing machine

(75) Inventor: Christian Behringer, Kirchardt (DE)

Correspondence Address: Lipsitz & McAllister, LLC, 755 MAIN STREET, MONROE, CT, 06468, US

(73) Assignee: Behringer GmbH, Kirchardt (DE)

(21) Appl. No.: 10/805,677

(22) Filed: Mar. 18, 2004

(30) Foreign Application Priority Data
Sep. 18, 2003 (DE) 103 45 353.9

(51) Int. Cl. B26D 5/00; B26D 7/06; B26D 1/00

(52) U.S. Cl. 83/13; 83/225; 83/373; 83/401; 83/794

(57) ABSTRACT

In order to produce a sawing machine including a plurality of drives and a control unit which is constructed in a simple manner in regard to the control of the drive system, it is proposed that a first drive and a second drive be controlled in such a manner that they are not operable at the same time and that the first drive and the second drive be coupled to a common frequency converter.

The present disclosure relates to the subject matter disclosed in German application No. 103 45 353.9 of Sep. 18, 2003, which is incorporated herein by reference in its entirety and for all purposes.

### BACKGROUND OF THE INVENTION

The invention relates to a sawing machine comprising a plurality of drives and a control unit.

Furthermore, the invention relates to a method for controlling the drive system of a sawing machine wherein a first drive drives a sawing tool and a second drive drives a work piece carriage.

Sawing machines of this type are known, for example, those of the HBP type from the company Behringer GmbH.

### SUMMARY OF THE INVENTION

In accordance with the present invention, a sawing machine of simple construction in regard to the arrangement for controlling the drive system is provided.

This is achieved in that a first drive and a second drive are controlled in such a manner that they are not operable at the same time and in that the first drive and the second drive are coupled to a common frequency converter.

By virtue of the solution in accordance with the invention whereby a common frequency converter is associated with the first drive and the second drive, the number of frequency converters that are needed can be minimized. One achieves cost savings thereby. Furthermore, the space needed in a switchbox or a switchgear cabinet is reduced. This also leads to a reduction in the number of heat sources in the switchgear cabinet whilst the number of electronic interference sources in the switchgear cabinet is reduced.

The sawing machine in accordance with the invention is thereby of more simple construction and is more trouble-free in operation.

In accordance with the invention, it is ensured that the first drive and the second drive are not activatable at the same time. This is possible for example, if the first drive is a drive for the saw and the second drive is a drive for a feed carriage for the work-pieces. The effect is thereby achieved that the frequency converter has to control at most one drive at a certain time point. In consequence, this enables a common frequency converter to be associated with the two drives.

In particular, the rotational speed of the first drive and the rotational speed of the second drive are adjustable by means of the frequency converter. A frequency converter converts the mains frequency, an alternating current of 50 Hz or 60 Hz for example, in order to control the rotational speed of the relevant drive by means of the converted frequency. The torque is thereby frequency-independent over a wide speed range. In accordance with the invention, both the first drive and the second drive—but not both simultaneously—can be controlled by a single frequency converter. In principle hereby, it is also possible to control at least one further drive if this is not operated at the same time as the first drive and the second drive.

In particular, the first drive and the second drive are activated at different times so that it is ensured that at most just one drive must be controlled by the frequency converter.

It is most particularly advantageous, if the frequency converter controls the first drive in accordance with a first set of parameters and if it controls the second drive in accordance with a second set of parameters. A functional separation with regard to the control of the drive system can thus be achieved. Usually, different drives have different requirements as regards, inter alia, the rotational speed, the torque (as determined by the frequency and the voltage), and as regards the direction of rotation, the speed or the ramp function. By the use of a first set of parameters and a second set of parameters which are respectively adapted to the first drive and to the second drive, the effect is achieved that the respective drive that is being controlled at a certain time point will run optimally despite being controlled by a common frequency converter. Further sets of parameters could also be provided for further drives.

In particular, the parameters for the first set of parameters and/or the second set of parameters are stored in the frequency converter, this thereby ensuring that the corresponding drive is controlled by the correct set of parameters. Parameters for further sets of parameters could also be stored in like manner. The parameters (corresponding to the first or second set of parameters) that are needed for a special drive can be activated by the control unit.

The first set of parameters and the second set of parameters are different. Parallel control of the first drive and the second drive is thereby impossible since even different starting values, such as the voltage and the frequency, have to be set for the different drives. Due to the solution in accordance with the invention whereby it is ensured that the two drives are not operated at the same time, a common frequency converter can nevertheless be used for controlling the first and the second drive (or further drives).

Hereby, at least one of the variables, voltage, frequency, direction of rotation, speed or ramp function is adapted to be set for the first drive and the second drive by means of the respectively associated sets of parameters.

It is expedient, if the action of switching between the first set of parameters and the second set of parameters were to be performed by means of the control unit. Switching between control of the first drive and control of the second drive is effected in this manner. The change-over is initiated by the control unit and is effected automatically for example at a suitable time point during a machine cycle.

For the same reason, it is expedient if provision is made for at least one switch or one circuit which is constructed in such a manner that at most one drive is controlled. The at least one switch or circuit may, for example, comprise a motor contactor. For example, provision is made for a respective motor contactor to be associated with the first drive and the second drive, and for ensuring that at least one of the two motor contactors is always open so that at most one of the two drives is being controlled.

In particular, provision is made for the first drive to drive a tool. In the case of a sawing machine, the tool is a sawing tool. In the case of a band saw, the tool is an endless strip of saw-blading (endless saw blade). Such a band-saw blade can usually be driven independently of a feed carriage for the work-pieces so that operations of the sawing machine are possible in which the drives for the sawing tool and a feed carriage do not have to be moved together.

It is expedient, if the second drive drives a carriage and in particular, drives a carriage in a conveyor device for the work-pieces.

The second drive then preferably drives a feed carriage for one or more work-pieces.

Furthermore, in accordance with the invention a method is provided with which the process of controlling the drive system of a sawing machine is effected in a more simple manner.

In accordance with the invention, this is achieved in that the control of the first drive and the control of the second drive is effected by a common frequency converter and in that the first drive and the second drive are operated at different times.

This solution in accordance with the invention has the advantages that have already been explained in connection with the sawing machine in accordance with the invention.

It is ensured in a preferable manner that the first drive and the second drive are not activated at the same time. If this is possible, then it is also possible to control the two drives—but not simultaneously—by means of a common frequency converter.

Further advantageous embodiments of the method in accordance with the invention have already been explained in connection with the sawing machine in accordance with the invention.

The following description of a preferred embodiment serves, in conjunction with the drawing, for a more detailed explanation of the invention.

### BRIEF DESCRIPTION OF THE DRAWINGS

FIG. 1 shows a side view of an exemplary embodiment of a sawing machine in accordance with the invention and

FIG. 2 shows an exemplary embodiment of a frequency converter.

### DETAILED DESCRIPTION OF THE INVENTION

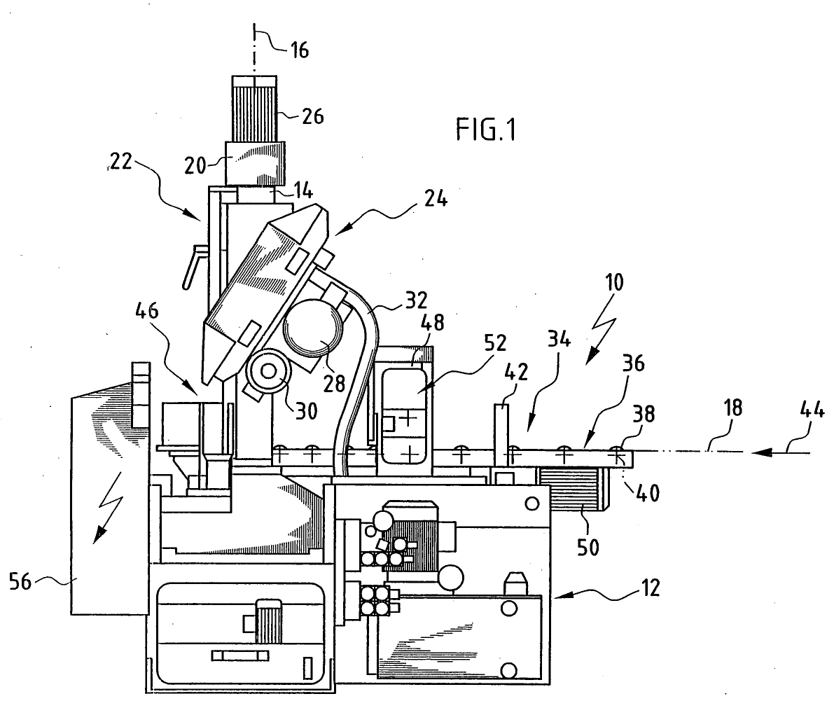

An exemplary embodiment of a sawing machine in accordance with the invention, which is shown in FIG. 1 and bears the general reference 10 therein, comprises the main frame 12 of the machine with the aid of which the sawing machine 10 is set up on a supporting base.

Two guide columns 14, which extend in the height direction 16, are fixed to the main frame 12 of the machine. (Only one column 14 is visible in FIG. 1.) The guide columns 14 project above a feed plane 18 for the work-pieces. In particular, the height direction 16 is perpendicular relative to the feed plane 18.

At the upper ends thereof, the guide columns 14 are interconnected by means of a connecting element 20 thereby forming a guidance portal 22 on which a sawing framework 24 is guided such as to be displaceable in the height direction 16. The displacement in the height direction 16 is effected by a sawing framework drive 26. The sawing framework drive 26 is an electric drive or a hydraulic drive for example.

The sawing framework 24 comprises a drive 28 for a sawing tool such as a continuous (endless) band-saw blade (which is not visible in FIG. 1). The saw drive 28 drives the band-saw blade on the sawing framework 24 in a circulating (unidirectional) movement in order to enable a saw cut to be made in a work piece.

Furthermore, a drive 30 for a cleaning brush, which serves to clean sawn shavings off the band-saw blade, is held on the sawing framework 24.

The drives 28, 30 on the sawing framework 24 are supplied with control signals and energy via lines, these lines being fed through a flexible tube 32 which enables the sawing framework 24 to be displaced in the height direction 16 on the guidance portal 22.

Furthermore, a conveyor device 34 for the work-pieces, which comprises a roller conveyer 36 incorporating spaced rollers 38 for example, is fixed to the main frame of the machine 12. The rotational axes 40 of these rollers 38 lie in a plane which is parallel to the feed plane 18. The feed plane 18 is formed by the contact surface between the rollers 38 and a work piece.

A work piece which is to be sawn, a steel girder for example, can be moved on the roller conveyer 36 by means of the conveyor device 34 to the guidance portal 22 where a saw cut can then be made by moving the sawing framework 24 downwardly whilst driving the band-saw blade therein.

In the case of the exemplary embodiment shown in FIG. 1, there are provided laterally of the roller conveyer 36 e.g. oppositely located strips 42 which serve as lateral stops so that a work piece cannot fall out sideways.

A chuck jaw device 46, which is fixed with respect to the feed direction 44 for the work-pieces, is arranged in the vicinity of the guidance portal 22. A work piece can be clamped between opposite chuck jaws of the chuck jaw device 46 in order to fix it with respect to the main frame of the machine 12 during a sawing process.

The conveyor device 34 has a carriage 48 which is moveable in the feed direction 44 (and in the opposite direction thereto). For the purposes of moving the carriage 48 in the feed direction 44 (parallel to the feed plane 18), there is provided a drive 50 which is arranged below the roller conveyer 36 for example. The drive 50 for the movement of the carriage 48 may be a spindle drive.

The carriage 48 preferably comprises a chuck jaw device 52 having two facing chuck jaws between which a work piece is adapted to be clamped. By moving the carriage 48 with the work piece clamped thereon, the work piece can then be fed to the guidance portal 22 and, in particular, be fed to the fixed chuck jaw device 46 in order to enable the work piece to be fixed for the purposes of making a saw cut therein.

It is possible for example, for the sawing process to be carried out in such a manner that a work piece being fed in, such as a steel girder for example, is clamped in the fixed chuck jaw device 46 whilst the sawing framework 24 is displaced upwardly during this feeding process and clamping process so that it is positioned outside the feed area for the work piece. After the work piece has been fixed, the sawing process is carried out by driving the sawing framework 24 downwardly.

Provision may then be made for the sawing framework 24 to be driven back up when the cut has been completed without moving the work piece itself. However, after completion of the saw cut and prior to the raising of the sawing framework 24, it is also possible for that part of the work piece that is fixed to the carriage 48 to be moved away from the band-saw blade against the feed direction 44 whereafter the sawing framework 24 is raised.

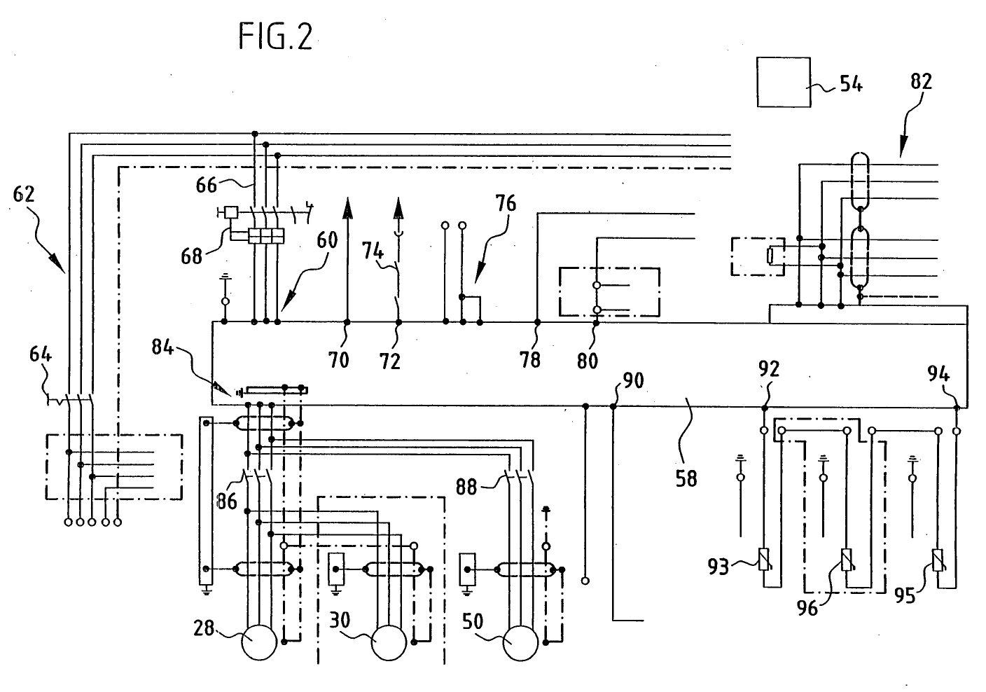

The corresponding processes are controlled by a control unit 54 (FIG. 2) such as an SPS control unit (stored-program, programmable control system) which is arranged, in particular, in a switchbox 56. The switchbox 56 is fixed to the main frame of the machine 12 for example.

The saw drive 28 forms a first drive and the drive 50 for the carriage 48 (a feed carriage for the work piece) forms a second drive which are adapted to be activated independently of one another. As long as a sawing process is taking place, i.e. as long as the band-saw blade is being driven by the saw drive 28, the carriage 48 must not be operated. In like manner, the band-saw blade must not be driven whilst the carriage 48 is being moved for the purposes of feeding-in a work piece or for removing a work piece, i.e. the saw drive 28 must not be activated.

In accordance with the invention, a common frequency converter 58 (FIG. 2) is associated with the drive for the saw 28 and the drive 50 for the carriage 48. This frequency converter 58 is connected to the control unit 54 and is accommodated in the switchbox 56.

A frequency converter serves for converting the mains (supply) frequency (which amounts to 50 Hz or 60 Hz for example). The corresponding drives (the drives 28, 30, 50 in the exemplary embodiment shown) are then fed with this converted frequency so that the rotational speed of the relevant drive and further variables can be set thereby.

A frequency converter 58 comprises for example, a rectifier, a buffer circuit and an inverter, the supplied alternating voltage being rectified by the rectifier. The buffer circuit then smoothes the DC voltage and the inverter produces a sine-weighted pulse-width modulated voltage from the DC voltage.

The output voltage and the effective output frequency can then be adjusted, this, in turn, therefore making it possible for the speed of the driving motor being controlled to be adjusted. The torque of the thus controlled drive can thereby be varied over a wide range and essentially independently of the rotational speed.

The frequency converter 58 is coupled via a feeder 60 to an alternating current supply line 62 over which, in particular, three-phase alternating current is supplied. A main switch 64 is arranged in the supply line 62 for the purposes of interrupting the supply line 62. Electrical energy is branched off to the frequency converter 58 from this supply line 62, whereby a protective switch 68 serving as a safety device is arranged upstream thereof in a corresponding branch 66 of the feeder 60. The frequency converter transforms this input voltage.

The frequency converter 58 has an output 70 for a current monitoring arrangement.

Furthermore, there is provided an output 72 for an automatic control arrangement which serves as a function-enabling arrangement for the frequency converter 58 and which incorporates a plurality of series-connected switches 74 in the path thereto. Enabling of the automatic control arrangement is only effected if all the switches 74 are closed. For example, one switch 74 is connected to a sensor which checks as to whether a protective door in the sawing machine 10 is closed. If this door is not closed, then the corresponding switch is opened and the automatic control arrangement is not enabled. A (cumulative) monitoring system for the hardware of the sawing machine 10 can thus be achieved with the aid of the output 72 and the downstream switches 74.

The frequency converter 58 is supplied with electrical energy via appropriate connections 76 so that it can accomplish its internal functions.

The feed speed in the direction of feed 44 is activated via digital inputs 78, 80, i.e. the appropriate speed parameter for the control of the drive 50 is specified. The corresponding inputs 78, 80 (as well as the outputs 70, 72 and the downstream switches 74) are connected to the control unit 54. (These connections are not shown in FIG. 2.)

Furthermore, a bus module 82 is connected to the frequency converter 58, said module likewise being connected to the control unit 54. Process data can thereby be set. For example, reference values can be entered and/or a parameterising process can be carried out. This is described in more detail hereinafter. A change of parameters can also be effected via the bus module 82. Furthermore, reversal of the direction of rotation can be controlled via the bus module 82. (Digital inputs could also be provided for the parameter changing process or the reversal of the direction of rotation.) Furthermore, data can be read-out from the frequency converter 58.

The frequency converter 58 comprises an output 84 for the frequency converted alternating voltage. In accordance with the invention, provision is made for this output 84 to be connected to the drive for the saw 28 and for it to be connected in parallel to the drive 50 for the carriage 48.

A motor contactor 86 for the saw drive 28 is connected downstream of the output 84 and a motor contactor 88 for the drive 50 is also connected downstream thereof.

However, the two drives 28, 50 are not effectively connected—as regards the functioning thereof—in parallel to the output 84, but rather, are controlled in such a way that either the saw drive 28 will run or the drive 50 will run (or that neither of the two drives 28, 50 should run); at most one of the drives 28, 50 is activated. An appropriate switch or an appropriate circuit serves for this purpose, said switch or circuit comprising the motor contactors 86 and 88, and it ensures that both drives 28, 50 are not operated at the same time.

The drive 30 for the cleaning brush is connected effectively in parallel with the drive 28 for the band-saw blade so that the cleaning brush is also activated when the saw drive 28 is running.

The frequency converter 58 also comprises a floating output 90 for conveying error messages from the frequency converter 58.

Furthermore, there is provided a first monitoring output 92 for a temperature sensor 93 for the drive 28 and a second output for a temperature sensor 95 for the drive 50. Hereby, the two temperature sensors 93, 95 are connected in series so that an appropriate warning signal is given or the entire device is switched off if at least one of the drives 28, 50 exceeds a temperature threshold.

Provision may also be made for one or more further temperature sensors 96 to be connected in series with the temperature sensors 93, 95, this or these further sensors being associated with special accessories whose temperatures should be monitored.

The saw drive 28 drives the band-saw blade. It runs at different speeds in dependence on the material of the work piece which is being sawn. It only rotates in one direction and is switched on or off depending upon the operational state.

The drive 50 for the carriage 48 provides for the feeding of a work piece to the guidance portal 22 and thus for the positioning of the work piece being sawn with respect to the band-saw blade. The carriage 48 can be moved in both the feed direction 44 and in the opposite direction. A plurality of speeds may be envisaged.

Accordingly, different sets of parameters are provided for the control of the saw drive 28 and the control of the drive 50, these parameters being stored in the frequency converter 58. These parameters can be activated for the purposes of selecting a particular set of parameters via the bus module 82 or the inputs of the frequency converter 58 for example. The parameters needed for the drives 28, 50 are stored in the frequency converter 58 and the sets of parameters predetermined by the control unit 54 then determine the starting values of the frequency converter 58 at the output 84 from which the appropriate drive 28 or 50 is controlled. In particular, the output voltage and/or the output frequency and/or the direction of rotation and/or the speed and/or the ramp functions are determined in correspondence with the associated set of parameters.

Hereby, only one set of parameters is effective at a certain time point, namely, the first set of parameters for the first drive 28 or the second set of parameters for the second drive 50 (or further sets of parameters for further drives). Accordingly, the appropriate set of parameters is enabled by a switch or a circuit so as to ensure that at most one of the two drives 28, 50 is in operation.

In principle, it is also possible for the frequency converter 58 to control further drives if these are independent of the drives 28, 50 to such an extent that they are not operated at the same time thereas nor at the same time as other further drives.

By virtue of the solution in accordance with the invention, only one frequency converter, namely, the frequency converter 58 is associated with the drives 28 and 50. Space savings in the switchbox 56 are thereby achieved; less heat is produced in the switchbox 56 and also fewer sources of electrical interference are present. It is usually the case that the power consumption of the saw-drive 28 is greater than the power consumption of the drive 50 for the carriage 48 (for example, a typical power consumption for the drive 28 is in the region of 3 kW or more for example, whilst a typical power consumption for the drive 50 is in the region of 1.5 kW). Due to the solution in accordance with the invention utilising a frequency converter 58 matched to the power consumption of the drive 28, the performance of the drive 50 can also be increased as necessary at little expense since the control process is of course being effected by the frequency converter 58 which is matched to the drive 28.

In accordance with the invention, control of the drives 28, 50 of the sawing machine 10 is effected by the frequency converter 58 which is common to the first drive 28 and the second drive 50. It is thereby ensured that the first drive and the second drive are operated at different times, i.e. they are not operated at the same time. In the case of a sawing machine 10, this can be achieved if the first drive 28 is a drive for the saw and the second drive 50 is a drive for a carriage 48 for feeding the work piece. The operational processes for a work piece in the sawing machine can be controlled in such a way that the two drives 28, 50 do not have to be operated at the same time.

1. A sawing machine comprising:
a plurality of drives; and
a control unit;
wherein a first drive and a second drive are controlled in such a manner that they are not operable at the same time and the first drive and the second drive are coupled to a common frequency converter.

2. A sawing machine in accordance with claim 1, wherein the rotational speed of the first drive and the rotational speed of the second drive are adjustable by the frequency converter.

3. A sawing machine in accordance with claim 1, wherein the first drive and the second drive are operated at different times.

4. A sawing machine in accordance with claim 1, wherein the frequency converter controls the first drive in accordance with a first set of parameters.

5. A sawing machine in accordance with claim 1, wherein the frequency converter controls the second drive in accordance with a second set of parameters.

6. A sawing machine in accordance with claim 5, wherein the parameters for at least one of the first set of parameters and the second set of parameters are stored in the frequency converter.

7. A sawing machine in accordance with claim 4, wherein the first set of parameters and a second set of parameters for controlling the second drive are different.

8. A sawing machine in accordance with claim 1, wherein at least one of the variables, voltage, frequency, direction of rotation, speed or ramp function is adjustable for each of the first drive and the second drive.

9. A sawing machine in accordance with claim 4, wherein switching between the first set of parameters and a second set of parameters for controlling the second drive is effected by the control unit.

10. A sawing machine in accordance with claim 1, wherein there is provided at least one switch or at least one circuit which is constructed in such a manner that at most one drive is controlled.

11. A sawing machine in accordance with claim 1, wherein the first drive drives a tool.

12. A sawing machine in accordance with claim 11, wherein the first drive drives a sawing tool.

13. A sawing machine in accordance with claim 12, wherein the first drive drives a band-saw blade.

14. A sawing machine in accordance with claim 1, wherein the second drive drives a carriage.

15. A sawing machine in accordance with claim 1, wherein the second drive drives a conveyor device for work-pieces.

16. A sawing machine in accordance with claim 15, wherein the second drive drives a feed carriage for one or more work-pieces.

17. A method for controlling the drive system of a sawing machine wherein a first drive drives a sawing tool and a second drive drives a work-piece carriage;
wherein the control of the first drive and the control of the second drive is effected by a common frequency converter and the first drive and the second drive are operated at different times.

18. A method in accordance with claim 17, wherein it is ensured that the first drive and the second drive are not activated at the same time.
